(19) United States
(12) Patent Application Publication
(10) Pub. No.: US 2004/0135790 A1
(43) Pub. Date: Jul. 15, 2004

(54) Correcting the color cast of an image

(75) Inventor: Lee C. Moore, Rochester, NY (US)

Correspondence Address: FAY, SHARPE, FAGAN,, MINNICH & McKEE, LLP, Seventh Floor, 1100 Superior Avenue, Cleveland, OH, 44114-2579, US

(73) Assignee: XEROX CORPORATION

(21) Appl. No.: 10/342,694

(22) Filed: Jan. 15, 2003

(51) Int. Cl. G09G 5/02

(52) U.S. Cl. 345/589

(57) ABSTRACT

Memory colors are colors of common objects that are known and recognized by most people of a common culture. For example, apple red, sky blue and flesh tones are memory colors. A method for correcting the color cast of an image includes selecting a portion of an image related to a memory color and indicating which memory color the selected portion should be. The color of the selected portion and the color of the memory color are compared. For example, a difference in chrominance, between the indicated memory color and the selected portion, is determined. The difference in chrominance is applied to colors of the image to generate an adjusted or corrected image. An image processing system operative to correct color cast includes a palette of memory colors and means for receiving an image portion selection and a memory color selection. A color cast calculator calculates a comparison vector. A color cast corrector shifts colors of the input image based on the comparison vector. In a xerographic environment, the system includes a xerographic print engine for rendering the adjusted image.

### BACKGROUND OF THE INVENTION

The invention is related generally to the art of image processing, and more specifically, to the art of color cast removal. The invention will be described in terms of a xerographic image-processing environment. However, the invention can be applied in other image-processing environments. For example, the invention can be applied in ionographic, lithographic, photographic, ink jet and other image-processing environments.

It is common in the image-processing art to receive images that have a color cast. For example, a light source can undesirably shift the color of an image. For instance, fluorescent lights are known to sometimes add a bluish green hue to an image. Taking photographs in the shade can add a blue cast to the resulting photograph. Photographing with film that is at or beyond its expiration date, can add a pink tint to an image. Using film that is balanced for daylight photography can add a yellowish cast to photographs taken indoors.

Many techniques are known for removing the color cast from an image. However, in most cases, the known techniques require the skill of a trained imaging-system operator. For example, a trained imaging system operator studies an image to determine which imaging parameters to adjust and to estimate an amount of change required in those parameters. An imaging system provides parameter adjusting means, such as, for example, sliders. For example, an imaging system may include Adobe Photoshop™. Photoshop™ provides sliders that allow a trained imaging system operator to change the amount of red, green and blue an image has. For instance, the operator can change the position of the sliders to enter the amount of change the operator estimates is required. The image is redisplayed based on the new position of the sliders. It is often necessary to repeat this process several times before the operator is satisfied with the resulting image. Sometimes color cast is removed from an image as a bi-product of setting the white point of an image.

Such slider-based cast removal techniques are often difficult for the inexperienced and unskilled system operator to use. For example, when an image has a yellow cast, it is difficult for the uninitiated to know which of, for example, red, green and blue sliders to adjust. Additionally, the inexperienced operator has difficulty in determining how much to adjust the sliders.

Therefore, there has been a desire for a method of removing color cast from an image that is simple and intuitive to even the untrained operator.

### SUMMARY OF THE INVENTION

A method for correcting a color cast of an image includes displaying the image, selecting a region of the image related to a memory color, displaying a pallet of memory colors, selecting a memory color from the displayed pallet to be associated with the selected region, calculating a difference between a color of the selected region and the selected memory color, and adjusting colors of the displayed image based on the calculated difference.

Selecting a memory color can include selecting a memory color from a listed plurality of memory colors.

Alternatively, selecting a memory color from a listed plurality of memory colors can include selecting a sticker associated with the memory color and placing the sticker on a printed version of the image.

In some embodiments, the method for correcting a color cast of an image includes identifying a memory color to be used in correcting the color cast of the image, selecting a portion of the image related to the memory color, converting colors of pixels of the image from image color space coordinates into standard color space coordinates, calculating an error vector between the standard color space coordinates of pixels of the selected portion and standard color space coordinates of the identified memory color, adjusting standard color space coordinates of colors of the image based on the calculated error, and converting the adjusted colors of the image from standard color space coordinates into image color space coordinates.

An image processing system operative to correct a color cast of an image includes, for example, a pallet of memory colors, an image portion selector, a memory color selector operative to allow a system operator to associate a memory color from the pallet with a selected portion of the image, a color cast calculator operative to determine a comparison vector between a color of the selected portion of the image and the associated memory color, and a color cast corrector operative to adjust colors of the image based on the comparison vector, thereby generating a color adjusted output image.

The image processing can also include a rendering device operative to render the color adjusted output image. In a xerographic environment the rendering device can be a xerographic print engine. In other environments the rendering device can include a lithographic print engine, a photographic print engine, a inkjet print engine, cathode ray tube, a liquid crystal display or other display device.

Advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various procedures and arrangements of procedures. The drawings are not to scale and are only for purposes of illustrating a preferred embodiment and are not to be construed as limiting the invention.

FIG. 1 represents an image having a blue cast.

FIG. 2 shows the image of FIG. 1 displayed by imaging-processing software. A selection tool is used to select a region or portion of the image.

FIG. 3 shows the image of FIG. 1 displayed in the imaging processing software of FIG. 2. A portion or region of the figure has been selected and a palette of memory colors is presented to an imaging software user.

FIG. 4 illustrates a color space. A color of the selected region of FIG. 3 is located within the color space. A memory color associated with the selected region of FIG. 3 is also located within the color space.

FIG. 5 illustrates the color space of FIG. 4. Colors from the image of FIG. 1 are plotted.

FIG. 6 illustrates the image of FIG. 1 displayed by the image-processing software of FIG. 2 and FIG. 3. The blue cast of the image has been removed.

FIG. 7 illustrates the color space of FIG. 4. A color is plotted near a gamut boundary.

FIG. 8 is a flow chart summarizing a method for removing color cast from an image.

FIG. 9 is a block diagram illustrating a system operative to perform the method of FIG. 6.

### DETAILED DESCRIPTION OF THE PREFERRED EMBODIMENTS

A simple method for removing a color cast from an image takes advantage of an intuitive concept referred to here as memory color. Memory colors are those colors commonly observed on a regular basis and recognized, by people from within a culture, from memory. For example, for many people, black, white, sky blue, apple red and skin tones are memory colors.

Many images include objects that are related, by observers, with memory colors. In fact, it is through the observation of objects related with memory colors, that the color cast of many images is recognized. The fact that an image includes an object related with a memory color can be used to advantage in correcting a color cast of the image.

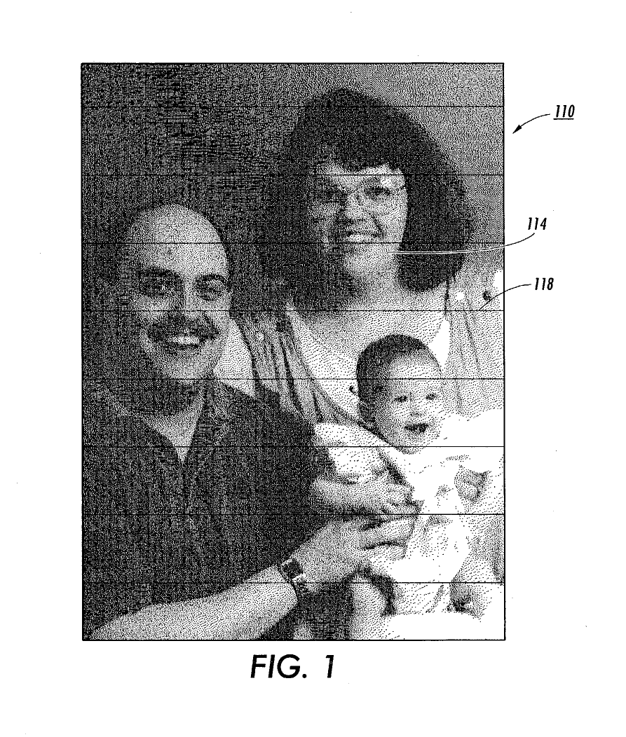

For example, referring to FIG. 1, an exemplary image 110 includes an object related to a memory color. The object is a person 114, the memory color is a flesh tone. The image 110 includes a blue color cast 118. The color cast 118 makes the flesh tone look bluer than it should, and an observer of the image quickly recognizes that the image includes a color cast.

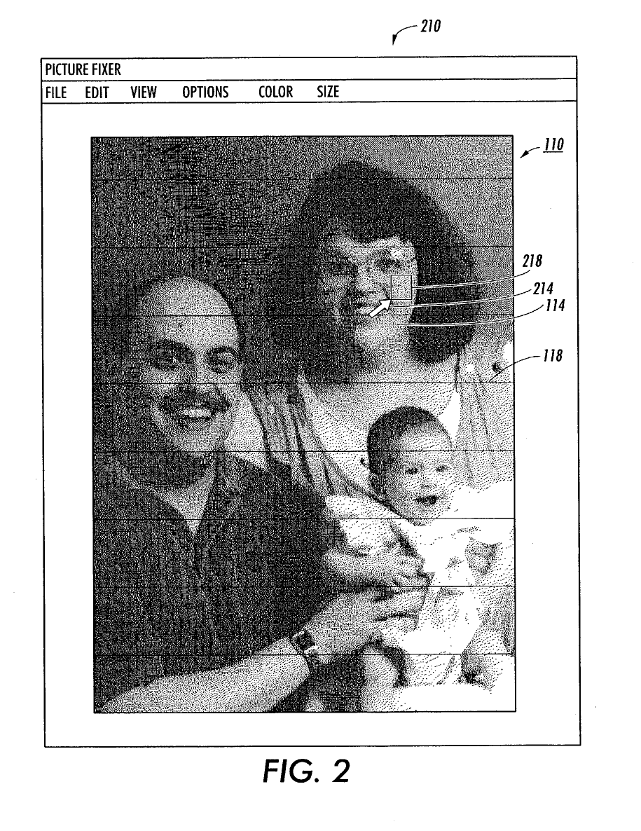

Referring to FIG. 2, the image 110 can be processed by image-processing software 210. The image-processing software 210 includes a selection tool 214. The selection tool 214 can be used to select or indicate regions of the image. For example, the selection tool 214 can be used to select a region 218 associated with a memory color. For instance, the memory color associated by a user with the selected region 218 is a flesh tone.

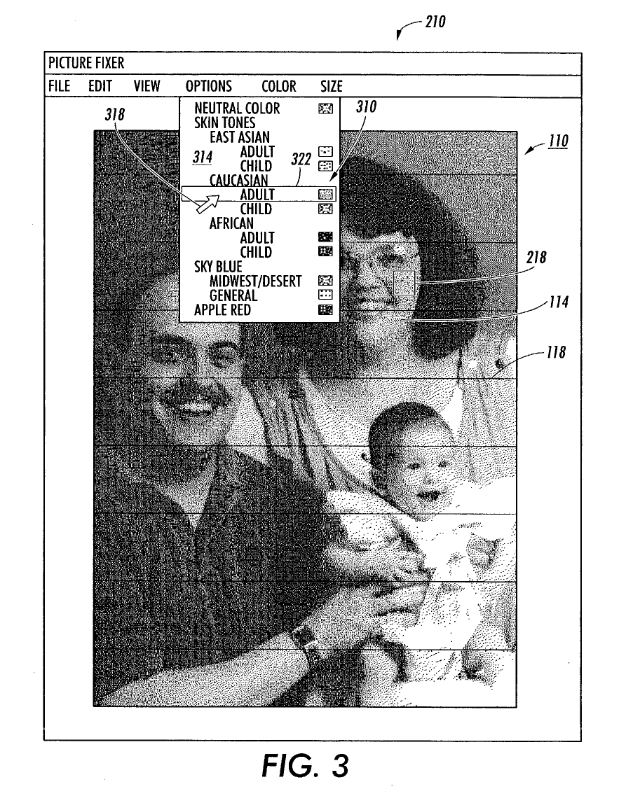

Referring to FIG. 3, the image-processing software 210 includes a database or palette 310 of memory colors. For example, the memory color palette 310 is displayed in a pull-down menu 314. The color palette 310 can be displayed other ways as well. For example, the memory color palette 310 can be displayed in a dialog box or any other convenient selection providing scheme.

A color palette selection tool 318 is used by a system operator to associate a memory color from the memory color palette 310 with the selected region 218 of the image 110. This selection or association indicates to the image-processing software 210 a color or chrominance the operator expects or prefers for the selected region 218. This indicated preference is used by the image-processing software 210 to correct the color cast 118 of the image 110.

The colors of the memory palette 310 and the colors of the image 110 are described in terms of a convenient color space. For example, the colors of the color palette 310 are described within or made available to the image-processing software 210 in terms of an L* a* b* color space defined by a lightness parameter L* and two chrominance parameters a* and b*. If necessary, the image-processing software 210 translates the colors of the image from some other descriptive form into the convenient color space (e.g.; L* a* b*).

If the selected region 218 includes pixels having a plurality of colors, the colors of the pixels are averaged together. For example, the average color is described in terms of an L* value, an a* value and a b* value. The L* a* b* value defines a vector in the L* a* b* space. Where a color cast is present, another set of L* a* b* values describes the memory color 322 selected from the palette 310 of memory colors.

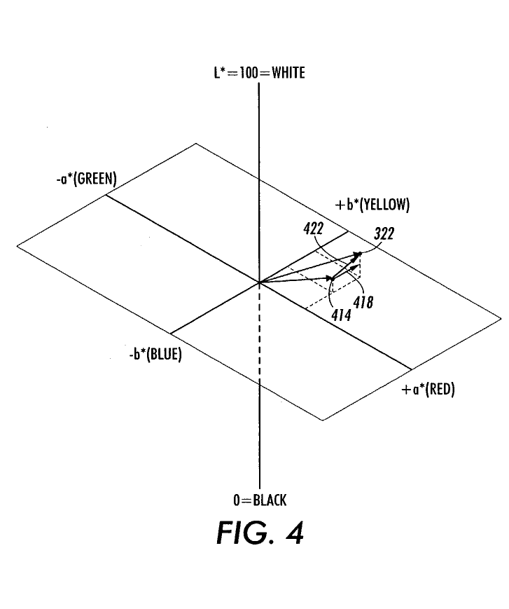

Referring to FIG. 4, since the input image 110 includes a blue cast 118, the average color 414 of the pixels in the selected region 218 has a lower or more negative b* value than the appropriately selected memory color 322. Additionally, as illustrated in the example of FIG. 4, the selected memory color 322 is lighter or more white than the average value 414 of the pixels of the selected region 218. Therefore, the selected memory color 322 has a higher L* value.

The image-processing software 210 compares the average color value of the pixels of the selected region 218 to the selected memory color 322. For example, the image-processing software 210 calculates or determines a chrominance difference, error, or comparison vector 418. The chrominance comparison vector 418 is defined by differences in the a* and/or b* values of the average color vector 414 of the pixels in the selected region 218 and the selected memory color 322. A total difference, error, or comparison vector 422 is defined by differences in the L*, a*, b* values of the average color 414 of the pixels in the selected region 218 and the selected memory color 322.

When correcting the color cast of an image, it is often preferable to adjust only the chrominance of the image. For example, when an object in an image is associated with a neutral memory color, it is usually desirable to preserve the luminance of the object and shift only the chrominance. Therefore, it is usually preferable to use the chrominance comparison vector 418 when adjusting or shifting the color values of the pixels of the image 110 and disregard the total difference, error, or comparison vector 422.

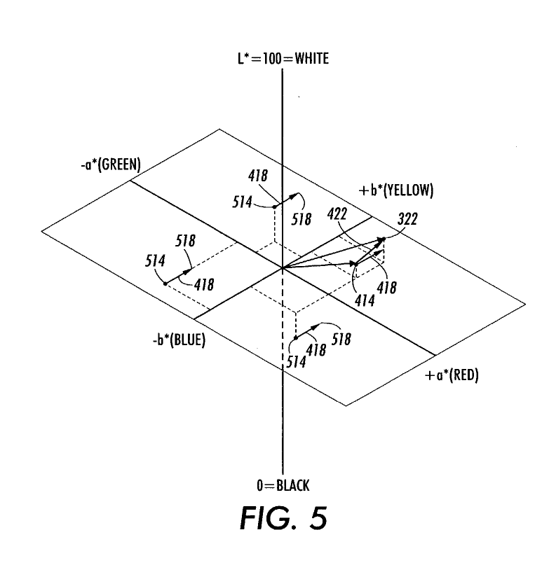

For example, referring to FIG. 5, colors 514 of pixels of the image 110 are shifted by an amount and in a direction defined by the chrominance comparison vector 418. The shifting yields corrected colors 518.

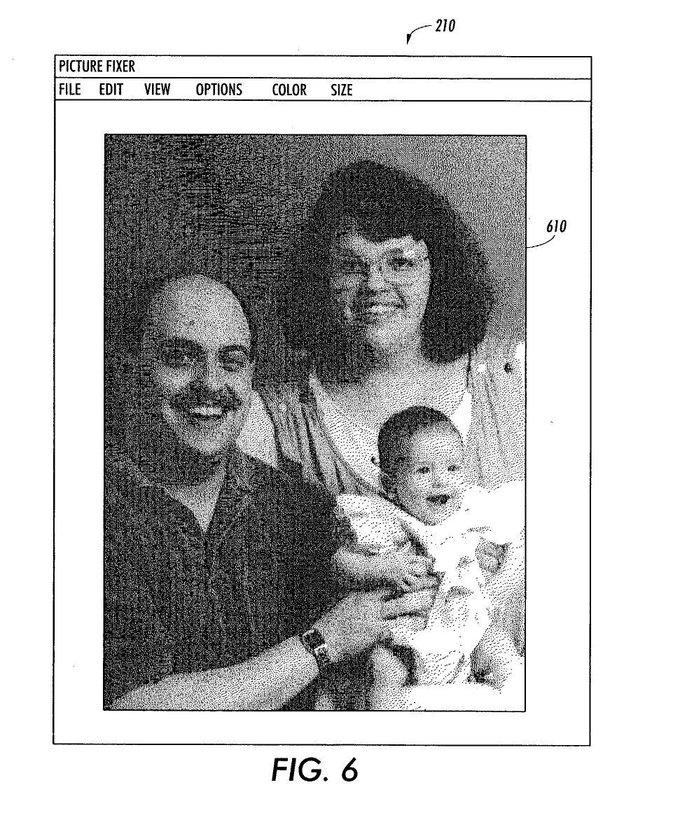

Referring to FIG. 6, the corrected colors 518 result in a corrected image 610. The color cast 118 is no longer present in the corrected image 610. The corrected image 610 can be stored for use in documents. Alternatively, the corrected image 610 can be rendered. For example, the corrected image 610 can be rendered by a xerographic print engine. Alternatively, the corrected image 610 can be rendered by other rendering devices, such as, but not limited to, for example, ionographic, lithographic, photographic and ink jet print engines, or the image can be displayed on electronic displays such as a cathode ray tube (CRT) or a liquid crystal display (LCD).

Alternatively, the colors 514 of the pixels of the image 110 can be shifted by other comparison vectors. For example, if it is desirable to shift the luminance of the image 110 toward a standard or reference luminance, the colors 514 can be shifted an amount and in a direction defined by the total difference or error vector 422. In the illustrated example, such a shift would both remove the chrominance cast of the image and a lightness cast of the image.

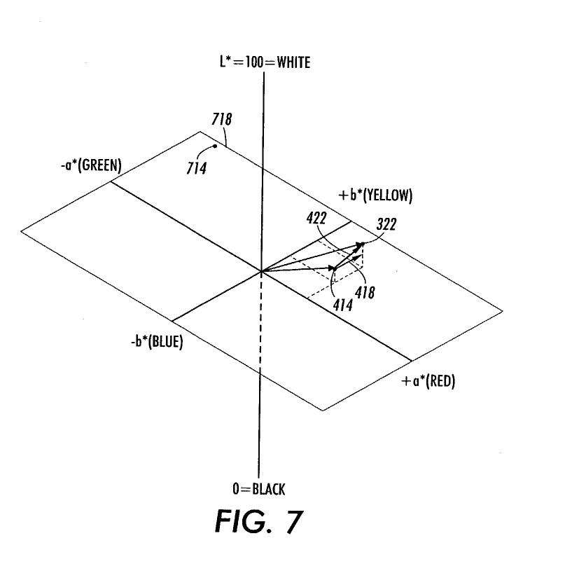

It is anticipated that some of the colors in an input image such as, input image 110, may be near a gamut boundary of, for example, a rendering device. For example, referring to FIG. 7, a color 714 of an image might be near a yellow gamut boundary 718 of a rendering device. Therefore, it is possible that shifting the color 714 according to the full magnitude and direction of a comparison vector such as difference or error vectors 418, 422 could cause truncation or saturation problems. However, most color casts are slight in nature, and it is expected that such truncation problems will be insignificant.

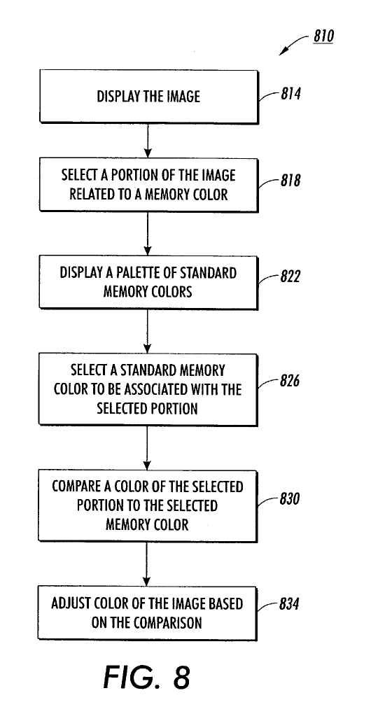

Referring to FIG. 8, in summary, a method 810 for correcting the color cast of an image includes displaying 814 the image, selecting a portion of the image 818 related with a memory color, displaying a palette 822 of standard memory colors, selecting a standard memory color 826 from the palette to be associated with the selected portion, comparing 830 a color of the selected portion to the standard memory color, and adjusting 834 colors of the image based on the comparison.

Displaying 814 the image can include displaying the image on a computer display, such as a cathode ray tube (CRT), liquid crystal display (LCD) or other video device. Alternatively, a printed version of the image can be considered a display of the image.

Selecting a portion of the image 818 associated with a memory color can include using a computer pointing device, such as, for example, a mouse, track ball or light pen to select a portion of an image displayed on a video device. However, image portion selection can also be indicated on a printed version of the image. For example, a symbol can be placed at or near a selected portion of the image. Such a symbol might be hand drawn or available in the form of a sticker to be placed on the paper version of the image. Displaying a palette 822 of standard memory colors can include displaying a palette in a pull down menu or dialog box, or any other choice presentation scheme. Alternatively, a palette of standard memory colors might be displayed in printed form. For example, a palette of standard memory colors might be printed in association with the selection stickers mentioned above. Each memory color might be associated with a different selection sticker. For example, a selection sticker includes a data glyph. A data glyph indicates a memory color to be associated with a portion of the image adjacent to where the sticker is placed.

Selecting a standard memory color 826 to be associated with the selected portion can include using a computer pointing device such as a mouse, track ball or light pen to select a standard color from a displayed palette in a pull down menu, dialog box or other choice presentation scheme. Alternatively, as mentioned above, selecting a standard memory color 826 can comprise applying a symbol or data glyph to a physical version of the image. Of course, selecting a standard memory color 826 usually includes selecting an appropriate standard memory color. For example, selecting an appropriate standard memory color can include selecting a standard apple red memory color to be applied to an apple that should be apple red, or selecting desert sky blue as a standard memory color to be associated with a blue sky in a desert scene. However, certain special effects may be achieved by mismatching the standard memory colors with image portions. For example, where a selected portion of the image is associated with the flesh tone of a Caucasian adult, selecting desert sky blue as the memory color may shift the colors of the image in a desired artistic direction. In such instances, selecting an appropriate standard memory color comprises selecting a mismatched memory color.

Comparing 830 a color of the selected portion to the selected standard memory color includes, for example, subtracting a vector describing an average color of the pixels within the selected portion from a vector corresponding to the selected standard memory color. The vectors can be associated with chrominance aspects of the colors. Alternatively, the vectors can include luminance aspects instead of, or in addition to, chrominance aspects.

Alternatively, comparing 830 a color of the selected portion to the selected standard memory color can include comparing a plurality of colors of the pixels within the selected portion to the standard memory color. Comparing a plurality of colors to the standard memory color yields, for example, a plurality of comparison vectors. The plurality of comparison vectors can be combined, for example, by averaging, to yield a single average comparison vector.

Adjusting 834 the color of the image based on the comparison can include, for example, shifting the colors of the image a distance and direction indicated by the comparison vector.

An image processing system 910 operative to perform the above-described method 810 for correcting a color cast of an image includes an image input device 914, an image portion selector 918, a palette of memory colors 922, a memory color selector 924, a color cast calculator 926, a color cast corrector 930, an image storage or transmission device 934 and/or a rendering device 938.

The image input device 914 can be, for example, an image scanner, computer network interface, or a computer media interface such as a floppy disc drive, CD ROM drive or any other device for receiving an input image 916.

The image portion selector 918 can be any means for indicating a selected region or portion of an image. For example, the image portion selector 918 can include software in communication with the computer pointing device, such as a mouse, track ball, or light pen, and in communication with a video display device such as a CRT or LCD. The image portion selector receives signals from the pointing device and allows the system operator to indicate a selected region or portion of the image displayed on the computer display device. Alternatively, the image portion selector 918 comprises software, and or hardware that examines received input image for data glyphs, such as data glyphs associated with stickers as described above. The image portion selector 918 decodes the data glyphs as indicating a selected portion of the image.

The palette of memory colors 922 can include a database or other computer file associating, for example, memory color names with vectors in a convenient color space. Additionally, the palette of memory colors may include color patch images, such as thumbnail images, illustrating the associated memory colors. Alternatively, the palette of memory colors 922 can include information hard coated into a software module, such as, for example, the memory color selector 924.

The memory color selector 924 provides a means for associating memory color from the palette of memory colors 922 with the selected portion of the image. For example, the memory color selector provides a menu or dialog box for displaying text and/or thumbnail images describing the palette of memory colors. The memory color selector 924 communicates with a computer selection tool, such as a mouse, track ball, light pen, or keyboard, and accepts a memory color selection, for example, an image processing system operator. Alternatively, a memory color selector interprets data glyph information received, for example, from the image portion selector 918 or from the image input device 914.

The color cast calculator 926 receives image portion selection information from the image portion selector 918. Additionally, the color cast corrector 926 receives memory color selection information from the memory color selector 924. The image portion selection information includes color information associated with pixels within the selected region of the input image. For example, the color information includes an average color of the pixels within the selected region. Alternatively, the color information includes the color of a plurality of pixels within the selected region. If necessary, the color information is transformed into coordinates or vectors in a convenient color space. For instance, the color information is transformed into a color space used to describe the colors of the palette of memory colors 922 (e.g. an L* a* b* color space).

The color cast calculator 926 compares the color information received from the image portion selector 918 to the selected memory color information received from the memory color selector 924. For example, the comparison is a comparison of chrominance values of the color information received from the image portion selector and the selected memory color. When the convenient color space is L* a* b*, the comparison can be a difference calculation between a* and b* components of the selected memory color and a* and b* components of the color information received from the image portion selector 918. The comparison yields one or more comparison vectors. For example, a* and b* components of an average color received from the image portion selector 918 are subtracted from a* and b* components of a memory color received from the memory color selector 924. Alternatively, a* b* values of the colors of a plurality of pixels within the selected region are individually subtracted from the a* b* values of the selected memory color to yield a plurality of comparison vectors. In this case, the plurality of comparison vectors are combined to yield an average comparison vector.

Alternatively, the color cast corrector 926 can perform different comparisons, for example, the comparisons can include a comparison of luminance components of the color information received from the image portion selector 918 and the selected memory color. In yet further alternatives, the comparison can be based on individual color parameters, such as, for example, simply on L* or a* or b*. Such comparisons might be for producing special affects.

The color cast corrector 930 receives input image information from the image input device. Additionally, the color cast corrector 930 receives comparison vector information from the color cast corrector 926. If necessary, the color cast corrector 930 transforms the input image information into an image description based on the convenient color space. The color cast corrector 930 shifts the colors of the input image based on the comparison vector. For example, the comparison vector is added to or subtracted from (as is appropriate) color vectors of colors of the input image.

The color cast corrector 930 produces an output image 950. Where a display device is available, such as a CRT or LCD, the output image 950 can be displayed. A system operator can review the output image on the display and verify that the color cast has been properly adjusted. Additionally, or alternatively, the output image can be stored or transmitted by the image storage or transmission device 934. Additionally, the output image 950 can be rendered by the rendering device 938. For example, the rendering device 938 is a xerographic print engine. Xerographic print engines are known to include a user, a developer and an imaging member. Alternatively, the rendering device 938 can include an ionographic, lithographic, ink jet or other kind of print engine. Furthermore, the rendering device can be a display device such as a CRT, LCD or other electronic display.

The invention has been described with reference to particular embodiments. Modifications and alterations will occur to others upon reading and understanding the specification.

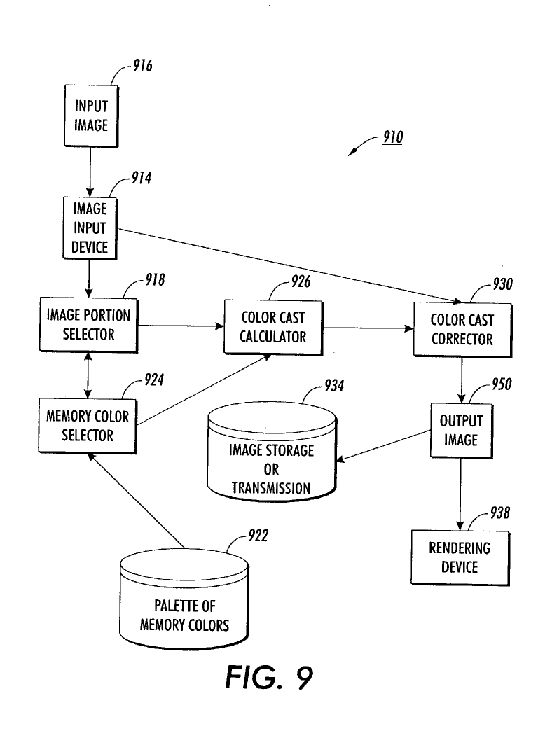

For example, the functions of the functional blocks described in reference to FIG. 9 can be performed by different functional blocks and arranged in different organizations. While for the most part, the described embodiment relies on the use of a computer display for communicating with a system operator in or order to receive selection information, a computer display is not required. For example, selection information can be included on a printed page, as described in reference to data glyph stickers. The printed page can be scanned and used to communicate selection information to the system. It is intended that all such modifications and alterations are included insofar as they come within the scope of the appended claims or the equivalents thereof.

What is claimed is:

1. A method for correcting a color cast of an image, the method comprising:
displaying the image;
selecting a region of the image related to a memory color;
displaying a pallet of memory colors;
selecting a memory color from the displayed pallet to be associated with the selected region;
calculating a difference between a color of the selected region and the selected memory color; and
adjusting colors of the displayed image based on the calculated difference.

2. The method for correcting a color cast of an image of claim 1 wherein displaying the image comprises displaying the image on a computer display and selecting a region of the image comprises using a computer based pointing device to indicate at least one pixel of the image.

3. The method for correcting a color cast of an image of claim 1 wherein selecting a memory color comprises selecting a memory color from a listed plurality of memory colors.

4. The method for correcting a color cast of an image of claim 3 wherein selecting a memory color from a listed plurality of memory colors comprises selecting a memory color from a text based list of named memory colors.

5. The method for correcting a color cast of an image of claim 3 wherein selecting a memory color from a listed plurality of memory colors comprises selecting a memory color from a plurality of displayed memory color patches.

6. The method for correcting a color cast of an image of claim 3 wherein selecting a memory color from a listed plurality of memory colors comprises selecting a sticker associated with the memory color and placing the sticker on a printed version of the image.

7. The method for correcting a color cast of an image of claim 1 wherein calculating a difference comprises calculating a distance in at least one dimension of a color space between the selected memory color and the color of the selected region.

8. The method for correcting a color cast of an image of claim 7 wherein calculating a distance in at least one dimension of a color space between the standard color and the color associated with the selected image portion comprises calculating a distance in a* and b*.

9. The method for correcting a color cast of an image of claim 8 wherein calculating a distance in at least one dimension of a color space between the standard color and the color associated with the selected image portion comprises calculating a distance in L*, a* and b*.

10. The method for correcting a color cast of an image of claim 7 wherein calculating a distance in at least one dimension of a color space between the selected memory color and color of the selected region comprises calculating a distance in hue.

11. The method for correcting a color cast of an image of claim 7 wherein calculating a distance in at least one dimension of a color space between the standard color and the color of the selected region comprises calculating a distance in saturation.

12. A method for correcting a color cast of an image, the method comprising:
identifying a memory color to be used in correcting the color cast of the image;
selecting a portion of the image related to the memory color;
converting colors of pixels of the image from image color space coordinates into standard color space coordinates;
calculating an error vector between the standard color space coordinates of pixels of the selected portion and standard color space coordinates of the identified memory color;
adjusting standard color space coordinates of colors of the image based on the calculated error; and
converting the adjusted colors of the image from standard color space coordinates into image color space coordinates.

13. The method for correcting a color cast of an image of claim 12 wherein adjusting standard color space coordinates of colors of the image comprises combining the error vector with the standard color space coordinates of pixels the image.

14. The method for correcting a color cast of an image of claim 12 wherein calculating an error vector between the standard color space coordinates of the selected portion and standard color space coordinates of the identified memory color comprises calculating an error vector in a*b* coordinates.

15. An image processing system operative to correct a color cast of an image, the image processing system comprising:
a pallet of memory colors;
an image portion selector;
a memory color selector operative to allow a system operator to associate a memory color from the pallet with a selected portion of the image;
a color cast calculator operative to determine a comparison vector between a color of the selected portion of the image and the associated memory color; and
a color cast corrector operative to adjust colors of the image based on the comparison vector, thereby generating an color adjusted output image.

16. The image processing system of claim 17 further comprising a rendering device operative to render the color adjusted output image.

17. The image processing system of claim 17 wherein the rendering device comprises a xerographic print engine.

18. The image processing system of claim 17 wherein the rendering device comprises at least one of a lithographic print engine, a photographic print engine, a inkjet print engine, cathode ray tube, and a liquid crystal display.
